(19) United States
(12) Patent Application Publication
(10) Pub. No.: US 2011/0146064 A1
(43) Pub. Date: Jun. 23, 2011

(54) Battery Manufacturing Using Laminated Assemblies

(75) Inventors: Timothy L. Feaver, Louisville, CO (US); Bernard Perry, Erie, CO (US); David Snyder, Broomfield, CO (US); Kirby W. Beard, Norristown, PA (US)

(73) Assignee: POROUS POWER TECHNOLOGIES, LLC, Lafayette, CO (US)

(21) Appl. No.: 12/872,491

(22) Filed: Aug. 31, 2010

Related U.S. Application Data
(60) Provisional application No. 61/238,476, filed on Aug. 31, 2009.

(51) Int. Cl. H01M 10/04

(52) U.S. Cl. 29/623.2; 29/623.1; 29/623.3; 29/623.4; 29/623.5

(57) ABSTRACT

A microporous battery separator may be laminated to electrodes and manipulated through manufacturing on a continuous roll of material. Batteries may be constructed by layering the laminated electrodes and separator into various configurations, including flat and wound cell batteries. The separator may or may not contain a nonwoven or other reinforcement, and may be laminated to the electrodes using several different methods.

### CROSS REFERENCE TO RELATED APPLICATIONS

This U.S. patent application claims priority to and benefit of U.S. Provisional Patent Application 61/238,476, filed 31 Aug. 2009 entitled “Battery Manufacturing Using Laminated Assemblies” and U.S. Provisional Patent Application 61/259,990, filed 10 Nov. 2009 entitled “Rapid, Reliable Assembly of Flat Plate Lithium Cells”, both of which are hereby expressly incorporated for reference for all they disclose and teach.

### BACKGROUND

Batteries of various battery chemistries are used in very large volumes commercially. Many devices that are sold in very high volumes contain batteries, such as cellular telephones and laptop computers. Also, batteries are used in very high volumes in automobiles such as hybrid automobiles.

In many cases, flat pack batteries are made up of various flat laminates and sealed into a container. Such batteries are used in portable electronics as well as automotive applications, but flat cell batteries are typically difficult to manufacture.

### SUMMARY

A microporous battery separator may be laminated to electrodes and manipulated through manufacturing on a continuous roll of material. Batteries may be constructed by layering the laminated electrodes and separator into various configurations, including flat and wound cell batteries. The separator may or may not contain a nonwoven or other reinforcement, and may be laminated to the electrodes using several different methods.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a cross-section of reinforced porous material.

FIG. 2 is a flowchart illustration of an embodiment showing a method for forming a porous material.

FIG. 3 is a diagram illustration of an embodiment showing a process for continuous manufacturing of reinforced porous material.

FIG. 4 is a diagram illustration of an embodiment showing a process for a dip method of continuous manufacturing of reinforced porous material.

FIG. 5 is a diagram illustration of an embodiment showing a one-sided laminating method for manufacturing a reinforced porous film.

FIG. 6 is a diagram illustration of an embodiment showing a two-sided laminating method for manufacturing a reinforced porous film.

FIG. 7 is a flowchart illustration of an embodiment showing a method for forming a porous material with loading materials.

FIG. 8 is a diagram illustration of an embodiment showing a schematic process for manufacturing battery laminates.

FIG. 9 is a diagram illustration of an embodiment showing a second schematic process for manufacturing battery laminates.

FIG. 10 is a diagram illustration of an embodiment showing a third schematic process for manufacturing battery laminates.

FIG. 11 is a diagram illustration of an embodiment showing an assembled laminate.

FIG. 12 is a diagram illustration of an embodiment showing an assembly process for battery construction.

FIG. 13 is a diagram illustration of an embodiment showing an assembly process for a wound battery construction.

### DETAILED DESCRIPTION

Batteries may be manufactured by first manufacturing a laminate comprising separator material to which are attached various battery components, such as anodes, cathodes, current collector foils, packaging films, and other materials. The various battery components may be adhered to the separator material when the separator material is formed or by a secondary operation such as adhesion or lamination.

After manufacturing several laminates, the laminates may be stacked, wound, or otherwise formed into a battery using several high volume manufacturing methods. Because the battery components are previously attached to the separator, the assembly process may be simplified over other methods where the battery components are not previously attached. A stacked flat cell battery design may be assembled by stacking and aligning several laminates. Once stacked, individual cells may be heat sealed and cut from the stacked laminates. A wound cell battery design may be assembled by winding or folding a section of laminate around itself. Other manufacturing processes may also be used with a laminate comprising a separator and various battery components.

The laminate may be manufactured by several different methods. In one embodiment, battery components such as electrodes and current collector foils may be placed on a conveyor belt. A nonwoven web may be saturated with a solution that forms the separator material, then the nonwoven web may be placed on top of the battery components. The separator material may gel and cure as the conveyor proceeds through an oven. The result may be a continuous roll of separator material that incorporates a reinforcing web with battery components adhered to the separator.

Other embodiments may manufacture the laminate in different manners. Other embodiments, for example, may fully cure the separator material and apply the battery components in a secondary process, using adhesive, heat lamination, or other joining processes.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

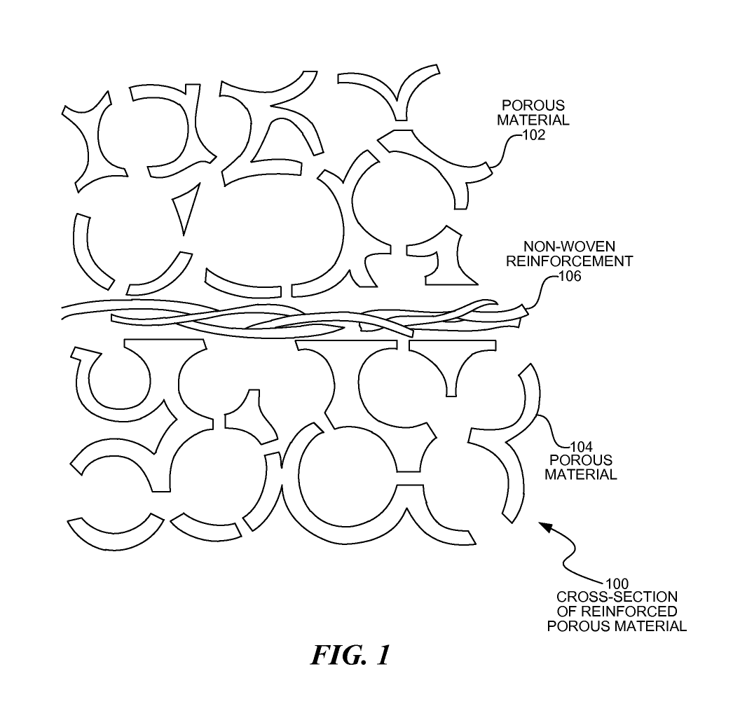

FIG. 1 is a schematic diagram of an embodiment 100 showing a cross section of porous material that may be formed using a solution of a polymer dissolved in a solvent and a miscible pore forming agent that has a higher surface energy. The porous material 102 and 104 is shown on both sides of a web 106.

FIG. 1 is not to scale and is a schematic diagram. In some embodiments, the porous material 102 and 104 may impregnate the non-woven web 106. Such embodiments may have partial impregnation or complete impregnation of porous material 102 and 104 into the thickness of the non-woven web 106. Some embodiments may have mechanical or chemical adhesion of the porous material 102 and 104 to the surface of the non-woven web 106. Other embodiments may vary in cross section based on the specific manufacturing process used and may have full impregnation or very little mechanical interlocking between the layers.

Embodiment 100 may be manufactured by several different methods. In some cases, the porous material 102 and 104 may be formed separately and bonded to the non-woven reinforcement 106. In other cases, the porous material 102 and 104 may be formed from a solution that may be applied to the reinforcement 106 in a liquid form and processed to yield the porous material 102 and 104 with the reinforcement 106.

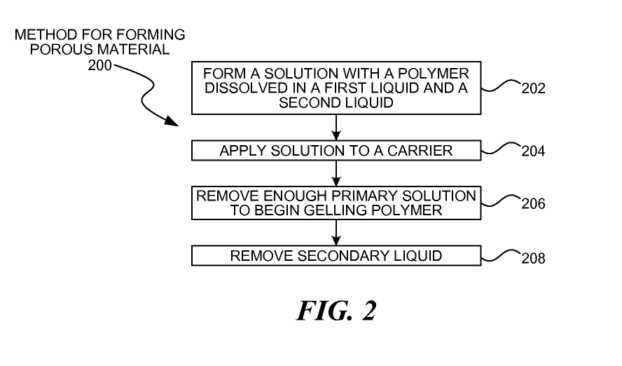

FIG. 2 is a flowchart diagram of an embodiment 200 showing a method for forming a porous material. Embodiment 200 is a general method, examples of which are discussed below.

In block 202, a solution may be formed with a polymer dissolved in a first liquid and a second liquid that may act as a pore forming agent. The liquids may be selected based on boiling points or volatility and surface tension so that when processed, the polymer is formed with a high porosity. Examples of such liquids are discussed below.

After forming the solution in block 202, the solution is applied to a carrier in block 204. The carrier may be any type of material. In some cases, a flat sheet of porous material may be cast onto a table top, which acts as a carrier in a batch process. In other cases, a film such as a polymer film, treated or untreated kraft paper, aluminum foil, or other backing or carrier material may be used in a continuous process. In such cases, a porous film may be manufactured and attached to a reinforcing web in a secondary process. In still other cases, the carrier material may be a nonwoven, woven, perforated, or other reinforcing web. In such cases, the solution may be applied by dipping, spraying, casting, extruding, pouring, spreading, or any other method of applying the solution.

The reinforcing web may be any type of reinforcement, including polymer based nonwoven webs, paper products, and fiberglass. In some cases, a woven material may be used with natural or manmade fibers, while in other cases, a solid film may be perforated, slotted, or expanded and used as a reinforcing web.

In block 206, enough of the primary liquid may be removed so that the dissolved polymer may begin to gel. In some embodiments, some, most, or substantially all of the primary liquid may be removed in block 206. As the polymer begins to gel, the mechanical structure of the material may begin to take shape and the porosity may begin to form. During this time, the material may have some mechanical properties so that different mechanisms may be used to remove any remaining primary liquid and the secondary liquid.

The secondary liquid may be removed in block 208. During the gelling process of block 206, the differences in surface tension between the various materials may allow the secondary liquid to coalesce and form droplets, around which the polymer may gel as the first liquid is removed. After or as the polymer solidifies, the second liquid may be removed. In some cases, the boiling point or volatility of the two liquids may be selected so that the primary liquid evaporates prior to the secondary liquid.

The mechanisms for removing the primary and secondary liquids may be any type of suitable mechanism for removing a liquid. In many cases, the primary liquid may be removed by a unidirectional mass transfer mechanism such as evaporation, wicking, blotting, mechanical compression or others. Some methods may use bidirectional mass transfer such as rinsing or washing. In some cases, one method may be used to remove the primary liquid and a second method may be used for the secondary liquid. For example, the primary liquid may be at least partially removed by evaporation while the remaining primary liquid and secondary liquid may be removed by rinsing or mechanically squeezing the material.

Three embodiments are presented below of formulations and methods of production for porous material.

In a first embodiment, the porous material may be formed by first forming a layer of a polymer solution on a substrate, wherein the polymer solution may comprise two miscible liquids and a polymer material dissolved therein, wherein the two miscible liquids may comprise (i) a principal solvent liquid that may have a surface tension at least 5% lower than the surface energy of the polymer and (ii) a second liquid that may have a surface tension at least 5% greater than the surface energy of the polymer. Second, a gelled polymer may be produced from the layer of polymer solution under conditions sufficient to provide a non-wetting, high surface tension solution within the layer of polymer solution; and, thirdly, rapidly removing the liquid from the film of gelled polymer by unidirectional mass transfer without dissolving the gelled polymer to produce the strong, highly porous, microporous polymer 102 and 104.

In a second embodiment, the porous material 104 may be produced using a method comprising:

(i) preparing a solution of one or more polymers in a mixture of a principal liquid which is a solvent for the polymer and a second liquid which is miscible with the principal liquid, wherein (i) the principal liquid may have a surface tension at least 5% lower than the surface energy of the polymer, (ii) the second liquid may have a surface tension at least 5% higher than the surface energy of the polymer, (iii) the normal boiling point of the principal liquid is less than 125° C. and the normal boiling point of the second liquid is less than about 160° C., (iv) the polymer may have a lower solubility in the second liquid than in the principal liquid, and (v) the solution may be prepared at a temperature less than about 20° C. above the normal boiling point of the principal liquid and while precluding any substantial evaporation of the principal liquid;

(ii) reducing the temperature of the solution by at least 5° C. to between the normal boiling point of the principal liquid and the temperature of the substrate upon the solution is to be cast;

(iii) casting the polymer solution onto a high surface energy substrate to form a liquid coating thereon, said substrate having a surface energy greater than the surface energy of the polymer; and

(iv) removing the principal liquid and the second liquid from the coating by unidirectional mass transfer without use of an extraction bath, (ii) without re-dissolving the polymer, and (iii) at a maximum air temperature of less than about 100° C. within a period of about 5 minutes, to form the strong, highly porous, thin, symmetric polymer membrane.

In a third embodiment, the porous material 104 may be produced by a method comprising:

(i) dissolving about 3 to 20% by weight of a polymer in a heated multiple liquid system comprising (a) a principal liquid which is a solvent for the polymer and (b) a second liquid to form a polymer solution, wherein (i) the principal liquid may have a surface tension at least 5% lower than the surface energy of the polymer, (ii) the second liquid may have a surface tension at least 5% greater than the surface energy of the polymer; and (iii) the polymer may have a lower solubility in the second liquid than it has in the principal solvent liquid;

(ii) reducing the temperature of the solution by at least 5° C. to between the normal boiling point of the principal liquid and the temperature of the substrate upon which it will be cast;

(iii) casting a film of the fully dissolved solution onto a substrate which may have a higher surface energy than the surface energy of the polymer;

(iv) precipitating the polymer to form a continuous gel phase while maintaining at least 70% of the total liquid content of the initial polymer solution, said precipitation caused by a means selected from the group consisting of cooling, extended dwell time, solvent evaporation, vibration, or ultrasonics; and

(v) removing the residual liquids without causing dissolution of the continuous gel phase by unidirectional mass transfer without any extraction bath, at a maximum film temperature which is less than the normal boiling point of the lowest boiling liquid, and within a period of about 5 minutes, to form a strong, highly porous, thin, symmetric polymer membrane.

The preceding embodiments are examples of different methods by which a porous material may be formed from a liquid solution to a porous polymer. Different embodiments may be used to create the porous material 102 and 104 and such embodiments may contain additional steps or fewer steps than the embodiments described above. Other embodiments may also use different processing times, concentrations of materials, or other variations.

Each of the embodiments of porous material 102 and 104 may begin with the formation of a solution of one or more soluble polymers in a liquid medium that comprises two or more dissimilar but miscible liquids. To form highly porous products, the total polymer concentration may generally be in the range of about 3 to 20% by weight. Lower polymer concentrations of about 3 to 10% may be preferred for the preparation of membranes having porosities greater than 70%, preferably greater than 75%, and most preferably greater than 80% by weight. Higher polymer concentrations of about 10 to 20% may be more useful to prepare slightly lower porosity membranes, i.e. about 60 to 70%.

A suitable temperature for forming the polymer solution may generally range from about 40° C. up to about 20° above the normal boiling point of the principal liquid, preferably about 40 to 80° C., more preferably about 50° C. to about 70° C. A suitable pressure for forming the polymer solution may generally range from about 0 to about 50 psig. In some embodiments, the polymer solution may be formed in a vacuum. Preferably a sealed pressurized system is used.

The material 102 may be formed in the presence of at least two dissimilar but miscible liquids to form the polymer solution from which a polymer film may be cast. The first “principal” liquid may be a better solvent for the polymer than the second liquid and may have a surface tension at least 5%, preferably at least 10%, lower than the surface energy of the polymer involved. The second liquid may be a solvent or a non-solvent for the polymer and may have a surface tension at least 5%, preferably at least 10%, greater than the surface energy of the polymer.

The principal liquid may be at least 70%, preferably about 80 to 95%, by weight of the total liquid medium. The principal liquid may dissolve the polymer at the temperature and pressure at which the solution may be formed. The dissolution may generally take place near or above the boiling temperature of the principal liquid, usually in a sealed container to prevent evaporation of the principal liquid. The principal liquid may have a greater solvent strength for the polymer than the second liquid. Also, the principal liquid may have a surface tension at least about 5%, preferably at least about 10%, lower than the surface energy of the polymer. The lower surface tension may lead to better polymer wetting and hence greater solubilizing power.

The second liquid, which may generally represent about 1 to 10% by weight of the total liquid medium, may be miscible with the first liquid. The second liquid may or may not dissolve the polymer as well as the first liquid at the selected temperature and pressure. The second liquid may have a higher surface tension than the surface energy of the polymer. Preferably, the second liquid may or may not wet the polymer at the gelation temperature though it may wet the polymer at more elevated temperatures.

Table A and Table B identify some specific principal and second liquids that may be used with typical polymers, especially including PVDF. Table A lists liquids that have at least some degree of solubility towards PVDF (surface energy of 35 dyne/cm), which may produce the dissolved polymer solution in the first step of the process. Ideally, a liquid may be selected from Table A that has solubility limits between 1% and 50% by weight of polymer at a temperature within the range of about 20 and 90° C. The liquids in Table B, on the other hand, may have lower polymer solubility than those in Table A, but may be selected because they have a higher surface tension than both the principal liquid and the polymers that may be dissolved in the solution made with liquid(s) from Table A.

Tables A and B represent typical examples of suitable liquids that may be used to create a porous material 102 and 104. Other embodiments may use different liquids as a principal liquid or second liquid.

Examples of suitable liquids for use as the principal liquid, along with their boiling point and surface tensions are provided in Table A below. The table is arranged in order of increasing boiling point, which is a useful parameter for achieving rapid gelling and removal of the liquid during the film formation step. In some applications, a lower boiling point may be preferred.

TABLE A

| | Normal Boiling | Surface Energy, |
|---|---|---|
| Principal Liquid | Point, EC | dynes/cm |
| methyl formate | 31.7 | 24.4 |
| acetone (2-propanone) | 56 | 23.5 |
| methyl acetate | 56.9 | 24.7 |
| Tetrahydrofuran | 66 | 26.4 |
| ethyl acetate | 77 | 23.4 |
| methyl ethyl ketone (2-butanone) | 80 | 24 |
| Acetonitrile | 81 | 29 |
| dimethyl carbonate | 90 | 31.9 |
| 1,2-dioxane | 100 | 32 |
| Toluene | 110 | 28.4 |
| methyl isobutyl ketone | 116 | 23.4 |

Examples of suitable liquids for use as the second liquid, along with their boiling point and surface tensions are provided in Table B below. This table is arranged in order of increasing surface tension as higher surface tension may result in optimum pore size distributions during the gelling and liquid removal steps of the process.

TABLE B

| | Normal boiling | Surface Energy, |
|---|---|---|
| Second Liquid | point, ° C. | dynes/cm |
| nitromethane | 101 | 37 |
| bromobenzene | 156 | 37 |
| formic acid | 100 | 38 |
| pyridine | 114 | 38 |
| ethylene bromide | 131 | 38 |
| 3-furaldehyde | 144 | 40 |
| bromine | 59 | 42 |
| tribromomethane | 150 | 42 |
| quinoline | 24 | 43 |
| nitric acid (69%) | 86 | 43 |
| water | 100 | 72.5 |

The porous material may be formed by using a liquid medium for forming the polymer solution. The liquid medium may be rapidly removable at a sufficiently low temperature so that the second liquid may be removed without re-dissolving the polymer during the liquid removal process. The liquid medium may or may not be devoid of plasticizers. The liquids that form the liquid medium may be relatively low boiling point materials. In many embodiments, the liquids may boil at temperatures less than about 125° C., preferably about 100° C. and below. Somewhat higher boiling point liquids, i.e. up to about 160° C., may be used as the second liquid if at least about 60% of the total liquid medium is removable at low temperature, e.g. less than about 50° C. The balance of the liquid medium can be removed at a higher temperature and/or under reduced pressure. Suitable removal conditions depend upon the specific liquids, polymers, and concentrations utilized.

Preferably the liquid removal may be completed within a short period of time, e.g. less than 5 minutes, preferably within about 2 minutes, and most prefer-ably within about 1.5 minutes. Rapid low temperature liquid removal, preferably using air flowing at a temperature of about 80° C. and below, most preferably at about 60° C. and below, without immersion of the membrane into another liquid has been found to produce a membrane with enhanced uniformity. The liquid removal may be done in a tunnel oven with an opportunity to remove and/or recover flammable, toxic or expensive liquids. The tunnel oven temperature may be operated at a temperature less than about 90° C., preferably less than about 60° C.

The polymer solution may become supersaturated in the process of film formation. Generally cooling of the solution will cause the supersaturation. Alternatively, the solution may become supersaturated after film formation by means of evaporation of a portion of the principal liquid. In each of these cases, a polymer gel may be formed while there is still sufficient liquid present to generate the desired high void content in the resulting polymer film when that remaining liquid is subsequently removed.

After the polymer solution has been prepared, it may then be formed into a thin film. The film-forming temperature may be preferably lower than the solution-forming temperature. The film-forming temperature may be sufficiently low that a polymer gel may rapidly form. That gel may then be stable throughout the liquid removal procedure. A lower film-forming temperature may be accomplished, for example, by pre-cooling the substrate onto which the solution is deposited, or by self-cooling of the polymer solution by controlled evaporation of a small amount of the principal liquid.

The film-forming step may occur at a lower temperature (and often at a lower pressure) than the solution-forming step. Commonly, it may occur at or about room temperature. However, it may occur at any temperature and pressure if the gelation of the polymer is caused by means other than cooling, such as by slight drying, extended dwell time, vibrations, or the like. Application as a thin film may allow the polymer to gel in a geometry defined by the interaction of the liquids of the solution.

The thin film may be formed by any suitable means. Extrusion or flow through a controlled orifice or by flow through a doctor blade may be commonly used. The substrate onto which the solution may be deposited may have a surface energy higher than the surface energy of the polymer. Examples of suitable substrate materials (with their surface energies) include copper (44 dynes/cm), aluminum (45 dynes/cm), glass (47 dynes/cm), polyethylene terephthalate (44.7 dynes/cm), and nylon (46 dynes/cm). In some cases a metal, metalized, or glass surface may be used. More preferably the metalized surface is an aluminized polyalkylene such as aluminized polyethylene and aluminized polypropylene.

In view of the thinness of the films, the temperature throughout may be relatively uniform, though the outer surface may be slightly cooler than the bottom layer. Thermal uniformity may enable the subsequent polymer precipitation to occur in a more uniform manner.

The films may be cooled or dried in a manner that prevents coiling of the polymer chains. Thus the cooling/drying may be conducted rapidly, i.e. within about 5 minutes, preferably within about 3 minutes, most preferably within about 2 minutes, because a rapid solidification of the spread polymer solution facilitates retention of the partially uncoiled orientation of the polymer molecules when first deposited from the polymer solution.

The process may entail producing a film of gelled polymer from the layer of polymer solution under conditions sufficient to provide a non-wetting, high surface tension solution within the layer of polymer solution. Preferably gelation of the polymer into a continuous gel phase occurs while maintaining at least 70% of the total liquid content of the initial polymer solution. More particularly, the precipitation of the gelled polymer is caused by a means selected from a group consisting of cooling, extended dwell time, solvent evaporation, vibration, or ultrasonics. Then, the balance of the liquids may be removed by a unidirectional process, usually by evaporation, from the formed film to form a strong micro-porous membrane of geometry controlled by the combination of the two liquids in the medium. In some embodiments, a liquid bath may be used to extract the liquids from the membrane. In other embodiments, the liquid materials may evaporate at moderate temperatures, i.e. at a temperature lower than that used for the polymer dissolution to prepare the polymer solution. The reduced temperature may be accomplished by the use of cool air or even the use of forced convection with cool to slightly warmed air to promote greater evaporative cooling.

The interaction among the two liquids (with their different surface tension characteristics) and the polymer (with a surface energy intermediate the surface tensions of the liquids) may yield a membrane with high porosity and relatively uniform pore size throughout its thickness. The surface tension forces may act at the interface between the liquids and the polymer to give uniformity to the cell structure during the removal step. The resulting product may be a solid polymeric membrane with relatively high porosity and uniformity of pore size. The strength of the membrane in some embodiments may be surprisingly high, due to the more linear orientation of polymer molecules.

The ratio of the principal liquid to the second liquid at the point of gelation may be adjusted such that the surface tension of the composite liquid phase may be greater than the surface energy of the polymer. The calculation of the composite liquid surface tension can be predicted based upon the mol fractions of liquids, as defined in “Surface Tension Prediction for Liquid Mixtures,” AIChE Journal, vol 44, no. 10, p. 2324, 1998, the subject matter of which is incorporated herein by reference.

Reid, Prausnitz, and Sherwood “The Properties of Gasses and Liquids”, 3d Ed, McGraw Hill Book Company p. 621.

Thermodynamic calculations show that adiabatic cooling of a solution can be significant initially and that the temperature gradient through such a film is very small. The latter may be considered responsible for the exceptional uniformity obtained using these methods.

The polymers used to produce the microporous membranes of the present invention may be organic polymers. Accordingly, the microporous polymers comprise carbon and a chemical group selected from hydrogen, halogen, oxygen, nitrogen, sulfur and a combination thereof. In a preferred embodiment, the composition of the microporous polymer may include a halogen. Preferably, the halogen is selected from the group consisting of chloride, fluoride, and a mixture thereof.

Suitable polymers for use herein may be include semi-crystalline or a blend of at least one amorphous polymer and at least one crystalline polymer.

Preferred semi-crystalline polymers may be selected from the group consisting of polyvinylidene fluoride, polyvinylidene fluoride-hexafluoropropylene copolymer, polyvinyl chloride, polyvinylidene chloride, chlorinated polyvinyl chloride, polymethyl methacrylate, and mixtures of two or more of these semi-crystalline polymers.

In some embodiments, the products produced by the processes described herein may be used as a battery separator. For this use, the polymer may comprise a polymer selected from the group consisting of polyvinylidene fluoride (PVDF), polylvinylidene fluoride-hexafluoropropylene copolymer (PVDF-HFP), polyvinyl chloride, and mixtures thereof. Still more preferably the polymer may comprise at least about 75% polyvinylidene fluoride.

The “MacMullin” or “McMullin” Number measures resistance to ion flow is defined in U.S. Pat. No. 4,464,238, the subject matter of which is incorporated herein by reference. The MacMullin Number is “a measure of resistance to movement of ions. The product of MacMullin Number and thickness defines an equivalent path length for ionic transport through the separator. The MacMullin Number appears explicitly in the one-dimensional dilute solution flux equations which govern the movement of ionic species within the separator; it is of practical utility because of the ease with which it is determined experimentally.” The lower a MacMullin Number the better for battery separators, the better. Products using these techniques may have a low MacMullin number, i.e. about 1.05 to 3, preferably about 1.05 to less than 2, most preferably about 1.05 to about 1.8.

Good tortuosity is an additional attribute of some embodiments. A devious or tortuous flow path with multiple interruptions and fine pores may act as a filter against penetration of invading solids. Tortuosity of the flow path can be helpful to prevent penetration by loose particles from an electrode or to minimize growth of dendrites through a separator that might cause electrical shorts. This characteristic cannot be quantified, except by long-term use, but it can be observed qualitatively by viewing a cross-section of the porosity.

Some embodiments may be generally uniform and symmetric, i.e. the substrate side pores may be substantially similar in size to the central and the air side pores. Pores varying in diameter by a factor of about 5 or less may be sufficiently uniform for the membranes to function in a symmetric manner.

Where additional strength or stiffness may be needed for handling purposes, micro- or nano-particles can be added to the formulation with such particulates residing within the polymer phase. A few such additives include silica aerogel, talc, and clay.

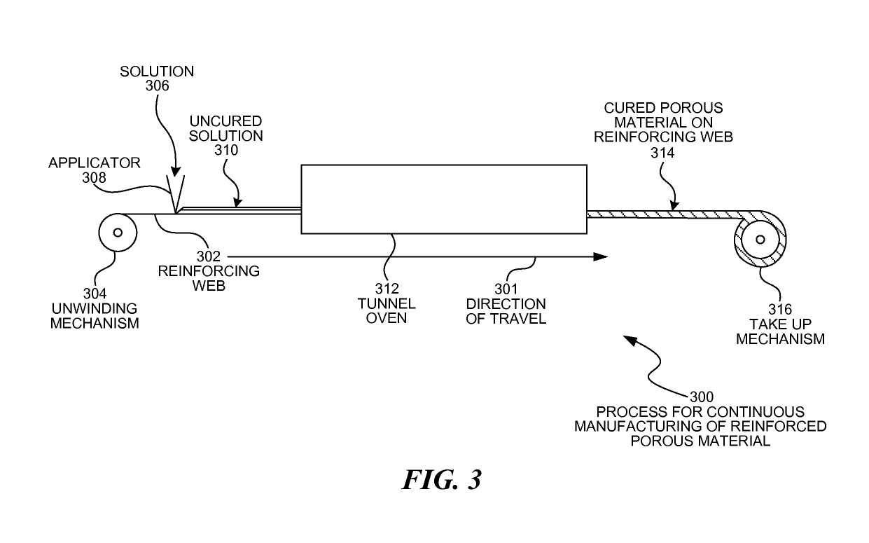

FIG. 3 is a diagram illustration of an embodiment 300 showing a process for continuous manufacturing of reinforced porous material. Embodiment 300 is an example of a general process that may be used to form porous material directly in a reinforced web, such as a nonwoven web, woven web, or perforated film.

A web 302 may be unwound with an unwinding mechanism 304 and moved in the direction of travel 301. Various reinforcement webs may be used, including woven and nonwoven. In many embodiments, a nonwoven web may be preferred from a cost standpoint.

As the web 302 is being moved in the direction 301, solution 302 may be applied to the web 302 with an applicator 308. The applicator 308 may apply a wet solution 306 to form an uncured solution 310.

In some embodiments, a carrier material may be used to facilitate handling of the web and may provide a bottom surface against which the liquid solution 306 may be supported while in the uncured state. Such carrier material may include treated kraft paper, various polymeric films, metal films, metalized carriers, or other material. Some embodiments may use a carrier material in subsequent manufacturing steps and may include the carrier material with the cured porous material 314 on the take up mechanism 316. In other embodiments, the carrier material may be stripped from the cured porous material 314 before the take up mechanism 316. In still other embodiments, a continuous recirculating belt or screen may be used beneath the web 302 during processing.

The embodiment 300 illustrates a manufacturing sequence that may be predominantly horizontal. In other embodiments, a vertical manufacturing process may have a direction of travel in either vertical direction, either up or down. A vertical direction of travel may enable a porous material to evenly form on two sides of a reinforcement web. Such an embodiment may have an applicator system that may apply solution to both sides of a reinforcement web. Horizontal manufacturing processes, such as embodiment 300, may result in a final product that may be asymmetrical, with the reinforcement web being located off the centerline of the thickness of the material.

The applicator 308 may be any mechanism by which the solution 306 may be applied to the web 302. In some embodiments, the solution 306 may be continuously cast, sprayed, extruded, or otherwise applied. Some embodiments may use a doctor blade or other mechanism to distribute the solution 306.

The thickness of the resulting reinforced porous material may be adjusted by controlling the amount of solution 306 that is applied to the web 302 and the speed of the web during application, among other variables.

Some embodiments may includes various additional processes, such as air knives, calendering, rolling, or other processing before, during, or after the solution 306 has formed into a solid porous polymer material.

The uncured solution 310 may be transferred through a tunnel oven 312 or other processes in order to form a cured porous material 314, which may be taken up with a take up mechanism 316.

The tunnel oven 312 may have different zones for applying various temperature profiles to the uncured solution 310 in order to form a porous material. In many cases, an initial lower temperature may be used to evaporate a portion of a primary liquid and begin formation of a solid polymer structure. A higher temperature may be used to remove a second liquid and remaining primary liquid.

In some embodiments, the tunnel oven 312 may provide air transfer using heated or cooled air to facilitate curing.

Embodiment 300 is an example of a continuous process for manufacturing a reinforced porous material by forming the porous material by introducing a wet solution directly onto the reinforcement media. Other embodiments may include casting a porous material directly onto a reinforced web in a batch mode, such as casting on non-moving table surface.

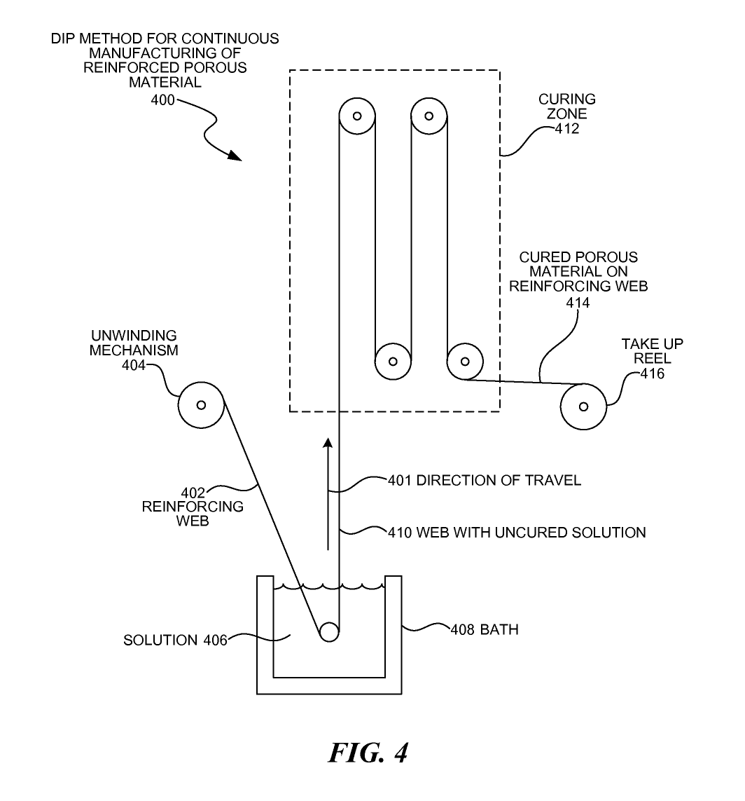

FIG. 4 is a diagram illustration of an embodiment 400 showing a dip method for continuous manufacturing of reinforced porous material.

A web 402 is unwound from an unwinding mechanism 404 and passed through a solution 406 in a bath 408 to form a web with uncured solution 410. The bath 408 may be ultrasonically activated to remove air and promote wetting of the reinforcement by the solution. The web may pass through a curing zone 412 in which may remove a primary and secondary liquid while forming a polymer with a porous structure. The cured material on a web 414 may be taken up in a take up reel 416.

Embodiment 400 is an example of a continuous process for forming a porous material directly onto a reinforcement web. By controlling the viscosity of the solution 406 and the speed of operation, a controlled thickness of porous material may be formed. In some embodiments, a doctor blade, calendering mechanism, air knives, or other mechanisms may be used to provide additional control over the thickness of the uncured or cured material.

The curing zone 412 may be any type of mechanism by which the uncured material 410 may be cured. Some embodiments may process the material through various heated or cooled zones, apply various rinses, process the material through a pressurized or vacuum environment, or provide some mechanical processing such as calendering, squeezing, or some other process. Each embodiment may have particular processing performed based on the selection of polymer, the formulation of the solution 406, and the construction of the reinforcing web 402.

In some embodiments, the reinforcing web 402 may have various treatments applied prior to coming in contact with the solution 406. For example, a sizing or other liquid material may be applied to the web 402. One example may be to pretreat the web 402 with a dilute version of the solution 406 or a solution with a different solvent/polymer combination. In some cases, such a pretreatment may cause the reinforcing web 402 to swell or otherwise improve the bonding of the porous material to the web 402. Other examples may include applying a corona or spray to the web 402 to partially oxidize the surface of the web 402. Another example may be to apply an electric charge to the web 402 and an opposite charge to the bath 408. Still another example may be to ionize the surface of the reinforcing web 402. Such pretreatment processes may be used with any method for manufacturing a reinforced porous film.

Ultrasonic activation of the solution 406 and reinforcing web 402 may enhance bonding and penetration of the solution 406 into the web.

Ultrasonic activation may be used to supplement any type of mechanism by which a pore forming polymer solution may be applied to a reinforcing web. In some embodiments, ultrasonic energy may be introduced to the solution, while in other embodiments, ultrasonic energy may be applied to the reinforcing web before or after the solution is applied. In embodiment 400, ultrasonic energy may be applied to the bath 408 or to the reinforcing web 402 prior to entering the bath 408. Some embodiments may introduce ultrasonic energy to the web after the solution is applied by using an ultrasonic horn directed toward the web.

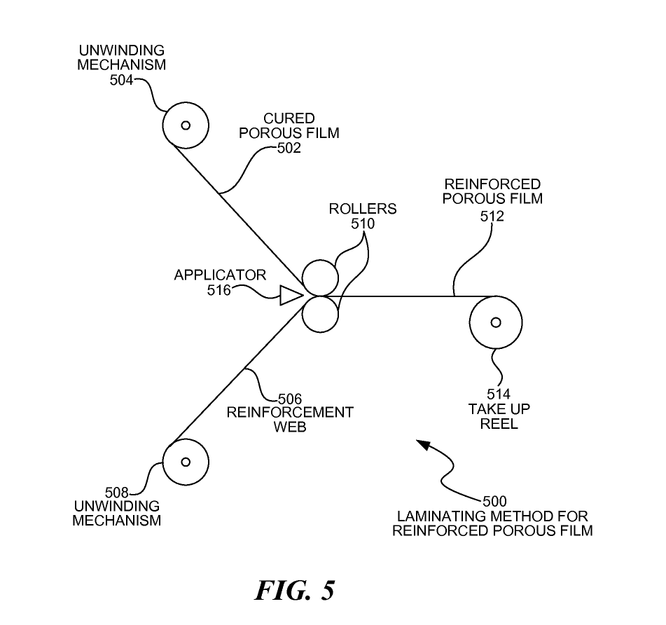

FIG. 5 is a diagram illustration of an embodiment 500 showing a method for laminating reinforced porous film. Embodiment 500 shows a single cured porous film 502 being joined to one side of a reinforced web 506.

The porous film 502 may be unwound from an unwinding mechanism 504 and brought into contact with a reinforcement web 506 that is unwound from a second unwinding mechanism 508. The two plies may be joined by the rollers 510 to form a reinforced porous film 512 that may be wound onto a take up reel 514.

Embodiment 500 is a method and apparatus for laminating a porous film 504 with a reinforcement web 506. In some embodiments, an applicator 516 may be used to deliver ionic charge, adhesive, heat, or any other material or processing at the nip point of the joining process.

An adhesive may be used to join the two layers. In some embodiments, the adhesive may contain a solvent that may enable a portion of either or both the polymer from the porous material or the reinforcement web to melt or dissolve and fuse with the other layer. In some cases, a polymer mixture may be used in forming the porous material with one of the polymers in the mixture selected to dissolve in an adhesive to facilitate the bonding to the reinforcement web. Another type of adhesive may contain a dissolved polymer that gels between the two layers to join the layers together. Another adhesive may be heat activated and may partially melt to join the layers.

When adhesives are used, some embodiments may apply a coating of adhesive across one or both of the surfaces to be joined. Other embodiments may apply spots of adhesive in various locations or patterns.

The applicator 516 may apply heat to one or more surfaces to be joined. In some embodiments, the heat may enable a portion of one or more of the materials to be joined to melt and fuse with the other. Such heat may be applied in conjunction with an adhesive.

In some embodiments, the porous film 502 and reinforcement web 506 may be joined together by mechanical interlocking. Such interlocking may be created by applying pressure between the rollers 510.

In some cases, the porous film 502 may be transferred through a portion of the manufacturing process using a carrier film or other material. In such a case, the carrier film may be removed prior to entering the rollers 510.

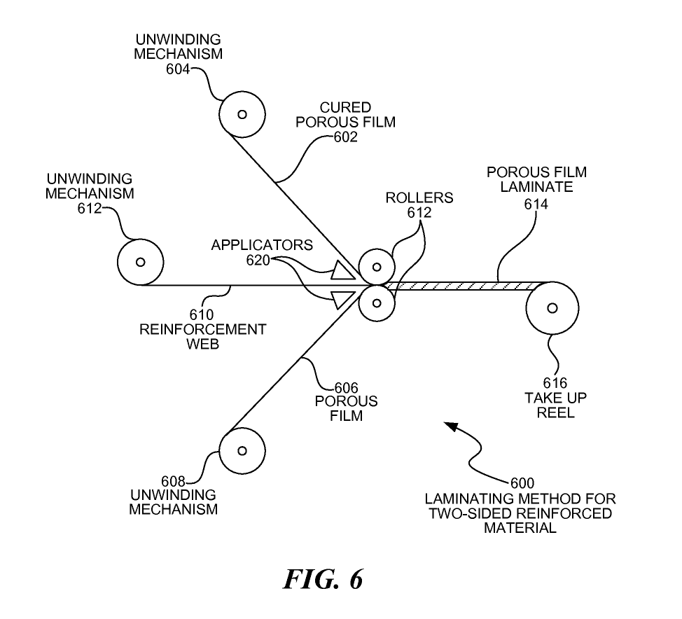

FIG. 6 is a diagram illustration of an embodiment 600 showing a laminating method for two-sided lamination of porous film onto a central reinforced web. Embodiment 600 may use similar processing to that of embodiment 500, with the addition of a second layer of porous film added so that the reinforcing web is in the center of the laminate.

A first porous film 602 may be unwound from an unwinding mechanism 604, and similarly a second porous film 606 may be unwound from unwinding mechanism 608. A reinforcement web 610 is unwound from an unwinding mechanism 612 and laminated between the porous film layers 602 and 606 at the rollers 612 to form a laminate 614 that is taken up by a take up reel 616.

Embodiment 600 may join the layers of porous film and a reinforcement web by any mechanism whatsoever. In some cases, mechanical interlocking may be used, while in other cases, applicators 620 may apply heat and/or adhesives or other bonding agent or processing that may facilitate bonding.

An adhesive may be used to join the various layers. In some embodiments, the adhesive may contain a solvent that may enable a portion of either or both the polymer from the porous material or the reinforcement web to melt or dissolve and fuse with the other layer. In some cases, a polymer mixture may be used in forming the porous material with one of the polymers in the mixture selected to dissolve in an adhesive to facilitate the bonding to the reinforcement web. Another type of adhesive may contain a dissolved polymer that gels between the two layers to join the layers together. Another adhesive may be heat activated and may partially melt to join the layers.

When adhesives are used, some embodiments may apply a coating of adhesive across one or both of the surfaces to be joined. Other embodiments may apply spots of adhesive in various locations or patterns.

The applicator 620 may apply heat to one or more surfaces to be joined. In some embodiments, the heat may enable a portion of one or more of the materials to be joined to melt and fuse with the other. Such heat may be applied in conjunction with an adhesive.

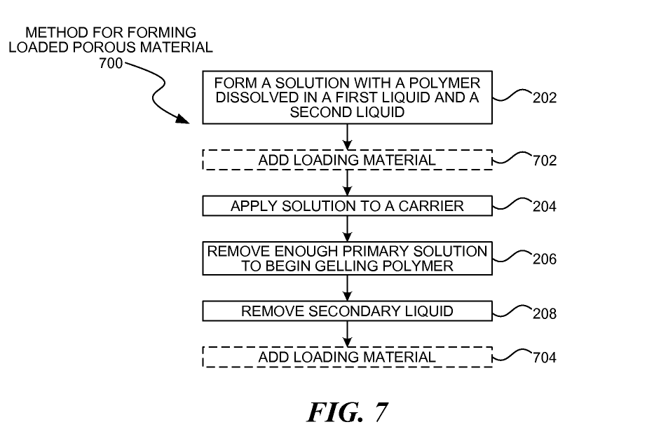

FIG. 7 is a flowchart illustration of an embodiment 700 showing a method for creating a loaded porous material. The loading may be any nonstructural material that may perform various functions.

In some cases, a loading may be passive and perform a function without changing state or engaging in a chemical reaction. In other cases, an active loading may undergo a chemical reaction or otherwise change state.

Loading may be applied using two different application mechanisms. In one mechanism, a loading may be incorporated into the porous material solution and may become bound into the structure of the porous material. In another mechanism, a loading may be applied to the porous material after formation and may be captured within the pores of the porous material.

In some embodiments, a two part loading material may be used. In such an embodiment, a first material may be incorporated into the solution and may be captured within the porous structure. A second part of the loading material may be applied to the formed porous material and the second part may interact with the first part to create the loading. In some cases, the second part may react with the first part or otherwise cause the first part to undergo a chemical transformation.

The illustration of FIG. 7 is a similar process as FIG. 2, with the addition of loading material prior to and/or after porous material formation.

The solution is formed in block 202 as described above.

Loading material may be added to the solution in block 702. The loading material may be dissolved in the solution of block 202 or may be a particulate that may be suspended in the solution.

The solution may be applied to a carrier in block 204, and enough of the primary solution may be removed in block 206 to begin gelation. The secondary liquid may be removed in block 208.

Loading material may be added in block 704 which may be after the porous material is formed. In such a case, the loading material may be infused within the porous structure in several manners. In some cases, the loading material may be dissolved in a solution which may permeate the porous material. The solution may be dried, leaving a residue of loading material.

In some cases, a particulate loading material may be infused into the porous structure as a dry material or with a liquid carrier.

In some embodiments, other mechanisms for depositing a loading material may include vacuum deposition mechanisms, surface treatments, or other mechanisms. In some embodiments, the loading material may be applied through the porous structure, while in other cases, the loading material may be applied to the outer surface of the porous structure.

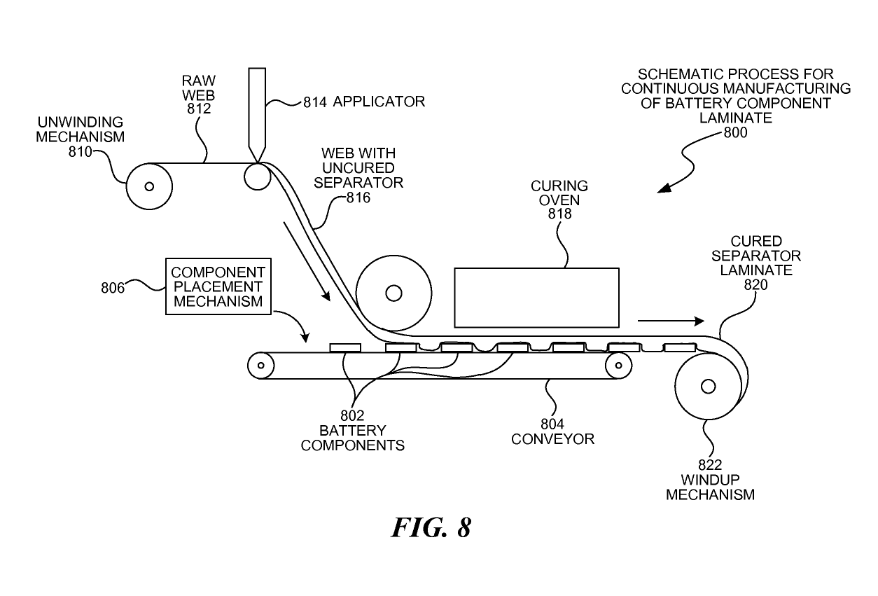

FIG. 8 is a schematic illustration of an embodiment 800 showing a process for continuous manufacturing of battery laminates. Embodiment 800 is a simplified illustration of a manufacturing process used to illustrate a mechanism and method for manufacturing a continuous laminate that contains a continuous battery separator onto which are bonded discrete battery components.

Embodiment 800 illustrates a manufacturing process where separator material is cured onto discrete battery components. During the curing process, the separator material may bond or adhere to the battery components, creating a laminate that can be assembled into multiple batteries in subsequent manufacturing steps.

Embodiment 800 shows a manufacturing process where battery components 802 are placed on a conveyor 804 by a component placement mechanism 806. The battery components 802 may be anodes, electrodes, conductive current conductive foils, packaging films, or other battery materials.

The battery components 802 may be discrete components so that when the laminate is cut, selected edges of the battery components may not be exposed and may be protected by a margin of separator material. For example, anodes and cathodes may be fully surrounded by separator material when cut from the final laminate. In such an example, excess separator material around the edges of the anodes and cathodes may prevent shorting within the battery.

In some cases, a portion of the battery components 802 may not be fully surrounded by the separator material. For example, current conductor tabs may be placed so that they extend past the edge of the separator material. After assembly, the current conductor tabs may be exposed for assembly to a pole of the battery.

The process illustrated by embodiment 800 may have an unwinding mechanism 810 that may unwind raw web material 812. The raw web material 812 may be any type of nonwoven or woven reinforcement. An applicator 812 may apply a solution of uncured separator material, and the web with uncured separator 816 may be joined to the battery components 802 on the conveyor 804. The separator material may be cured in a curing oven 818 to produce a cured separator laminate 820, which may be collected on a windup mechanism 822.

Embodiment 800 may have additional elements. For example, some embodiments may use a carrier layer beneath the battery components 802. The carrier layer may be a film or other material that may be removed prior to assembling the batteries and may serve as a strengthening member for the laminate 820 during processing.

When a carrier layer is used, some embodiments may omit the reinforcing web 812 and may apply the uncured separator material directly to the conveyor 802 which contains the battery components.

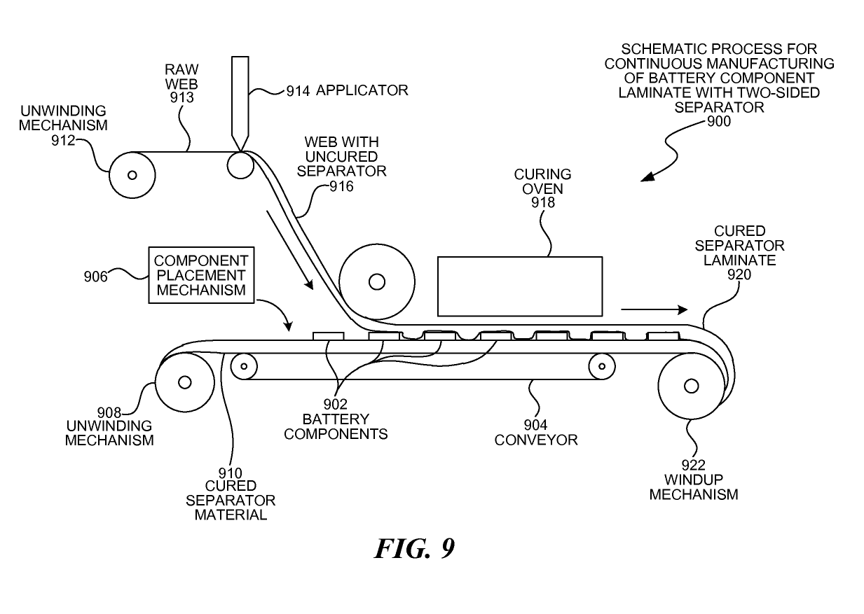

FIG. 9 is a schematic illustration of an embodiment 900 showing a process for continuous manufacturing of battery laminates. Embodiment 900 is a simplified illustration of a manufacturing process used to illustrate a mechanism and method for manufacturing a continuous laminate that contains two layers of continuous battery separator in between which are bonded discrete battery components.

Embodiment 900 is similar to embodiment 800, but creates a laminate with two layers of separator. Onto a previously cured separator are placed battery components, over which is cured a second layer of separator material. During the curing process, the separator material may bond or adhere to the battery components and the first laminate, creating a laminate that can be assembled into multiple batteries in subsequent manufacturing steps.

Embodiment 900 shows a manufacturing process where battery components 902 are placed on a conveyor 904 by a component placement mechanism 906. The battery components 902 may be anodes, electrodes, conductive current conductive foils, packaging films, or other battery materials.

The battery components 902 may be discrete components so that when the laminate is cut, selected edges of the battery components may not be exposed and may be protected by a margin of separator material. For example, anodes and cathodes may be fully surrounded by separator material when cut from the final laminate. In such an example, excess separator material around the edges of the anodes and cathodes may prevent shorting within the battery.

In some cases, a portion of the battery components 902 may not be fully surrounded by the separator material. For example, current conductor tabs may be placed so that they extend past the edge of the separator material. After assembly, the current conductor tabs may be exposed for assembly to a pole of the battery.

The battery components 902 may be placed on a cured separator material 910 that is supplied from an unwinding mechanism 908. In some embodiments, the battery components 902 may be attached to the cured separator material 910 by adhesive, heat bonding, or other method not shown in embodiment 900.

The process illustrated by embodiment 900 may have an unwinding mechanism 912 that may unwind raw web material 913. The raw web material 913 may be any type of nonwoven or woven reinforcement. An applicator 914 may apply a solution of uncured separator material, and the web with uncured separator 916 may be joined to the battery components 902 on the conveyor 904. The separator material may be cured in a curing oven 918 to produce a cured separator laminate 920, which may be collected on a windup mechanism 922.

The embodiment 900 illustrates a manufacturing process for a laminate that has two layers of separator material. In some embodiments, one or both of the separator layers may or may not contain reinforcing webs, such as woven or nonwoven webs.

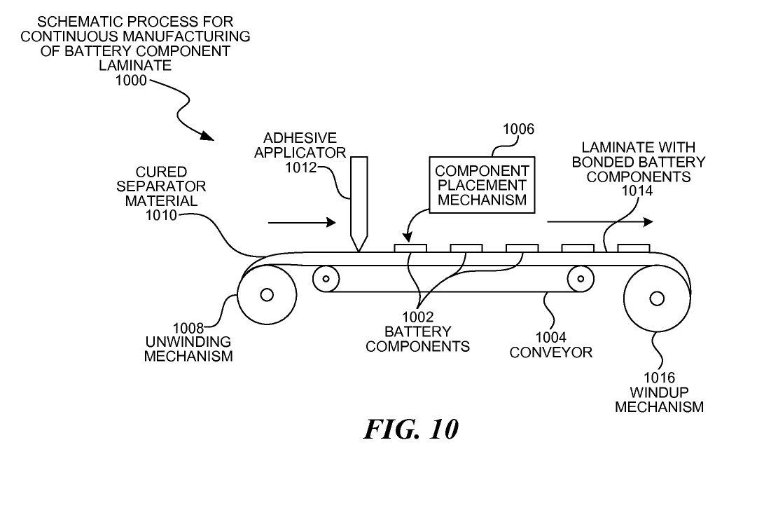

FIG. 10 is a schematic illustration of an embodiment 1000 showing a process for continuous manufacturing of battery laminates. Embodiment 1000 is a simplified illustration of a manufacturing process used to illustrate a mechanism and method for manufacturing a continuous laminate that contains discrete battery components that are bonded or adhered to a cured separator material.

Embodiment 1000 shows a manufacturing process where battery components 1002 are placed on a conveyor 1004 by a component placement mechanism 1006. The battery components 1002 may be anodes, electrodes, conductive current conductive foils, packaging films, or other battery materials.

The battery components 1002 may be discrete components so that when the laminate is cut, selected edges of the battery components may not be exposed and may be protected by a margin of separator material. For example, anodes and cathodes may be fully surrounded by separator material when cut from the final laminate. In such an example, excess separator material around the edges of the anodes and cathodes may prevent shorting within the battery.

In some cases, a portion of the battery components 1002 may not be fully surrounded by the separator material. For example, current conductor tabs may be placed so that they extend past the edge of the separator material. After assembly, the current conductor tabs may be exposed for assembly to a pole of the battery.

The battery components 1002 may be placed on a cured separator material 1010 that is supplied from an unwinding mechanism 1008. An adhesive application 1012 may apply adhesive so that the battery components 1002 adhere to the cured separator material 1010 to form a laminate with bonded battery components 1014 which may be wound onto a wind up mechanism 1016.

Various adhesives may be used. In some cases, the adhesives may be applied to the cured separator material 1010 or to the battery components 1002. In some embodiments, the adhesive may be applied to fully cover the interface between the battery components 1002 and the cured separator material 1010. In other embodiments, the adhesive may be applied using dots, stripes, or other patterns such that the adhesive is applied to only a portion of the interface between the battery components 1002 and the cured separator material 1010.

In other embodiments, the battery components 1002 may be laminated to the cured separator 1010. In such an embodiment, a heated laminating roller, preheat mechanism, laminating oven, or other device may be used to laminate the battery components to the cured separator.

In some embodiments, a carrier film may be used to convey the prepositioned battery components from a placement operation to a bonding or laminating operation. Such embodiments may place battery components onto a sacrificial carrier web to which the battery components may adhere. The carrier web may be used to transport the battery components and position the battery components during wet forming of the separator as in embodiments 800 and 900, or during an adhesive or lamination operation such as in embodiment 1000.

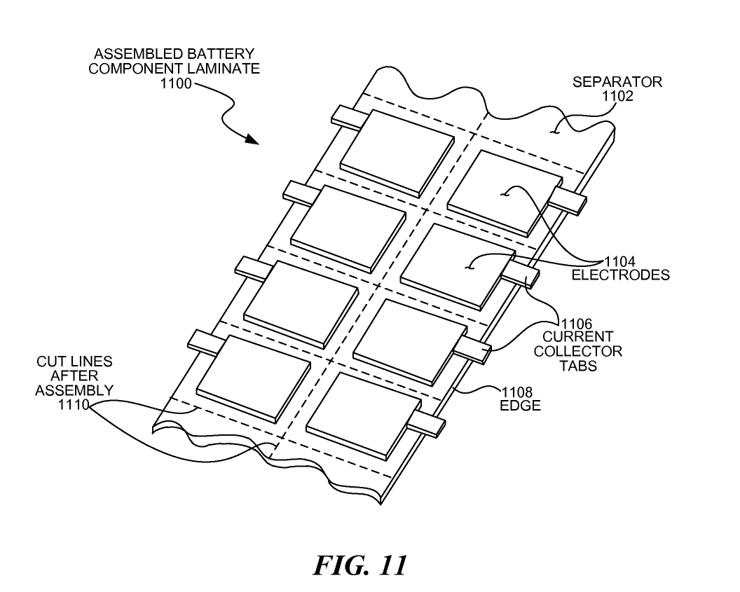

FIG. 11 is a schematic illustration of an embodiment 1100 showing an assembled battery laminate. Embodiment 1100 may be an example of a laminate created by the process of embodiments 900 or 1100.

The laminate of embodiment 1100 illustrates a separator 1102 onto which are placed various electrodes 1104. The electrodes may be anodes or cathodes, and are placed onto the separator 1102 such that the separator 1102 may surround all four sides of the electrodes 1104.

Each electrode may have a current collector tab 1106. Each current collector tab 1106 may be positioned so that current from the associated electrode 1104 may be brought out of an assembled battery laminate. As such, the current collector tabs 1106 may be positioned such that a portion of the current collector tab 1106 extends past the edge 1108 of the separator 1102.

When assembled into a battery configuration, the laminate of embodiment 1100 may be cut on the cut lines 1110 to form individual battery cells. In many cases, the cut lines 1110 may also be used to heat seal or fuse several layers of separator material 1102 together for efficient handling and for preventing an assembled battery from shifting.

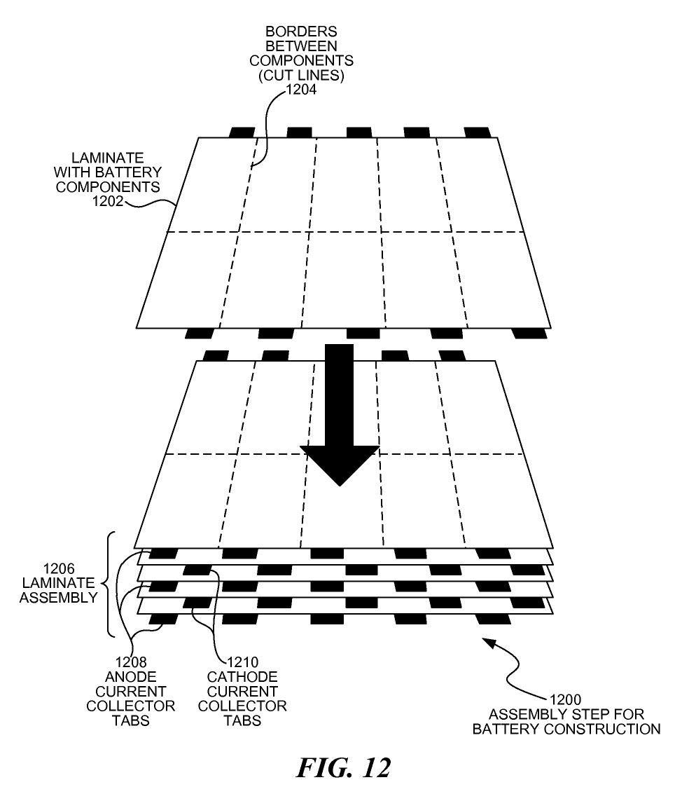

FIG. 12 is a schematic illustration of an embodiment 1200 showing an assembly of a multiple battery cells. Embodiment 1200 illustrates one method by which multiple battery cells may be manufactured using the laminates that may be produced using the methods illustrated in embodiments 800, 900, and 1000, as well as other embodiments.

A laminate 1202 with battery components may be stacked with several other laminates to create a laminate assembly 1206. The laminates are illustrated with cut lines 1204 that show where individual battery cells may be cut from the laminate assembly 1206.

Embodiment 1200 illustrates an embodiment where each laminate contains either anodes or cathodes. The various laminates are stacked together in an alternating manner to create battery cells.

The laminate assembly 1206 illustrates anode current collector tabs 1208 and cathode current collector tabs 1210. In the assembly, the respective current collector tabs are aligned with each other so that conductors may be attached to the collector tabs and routed to the appropriate terminal of the eventual battery.

After the various laminates are assembled together, the individual battery cells may be formed by cutting along the cut lines 1204. In some embodiments, the cutting operation may include a heat sealing operation to assist in transporting the battery cells without losing the proper orientation of the laminates and components.

In some embodiments, the laminate assembly 1206 may be assembled using heat, adhesives, or other bonding mechanisms between the various laminates. In other embodiments, the various laminates may be assembled using guide pins, assembly jigs, or other mechanisms for holding the laminates in place.

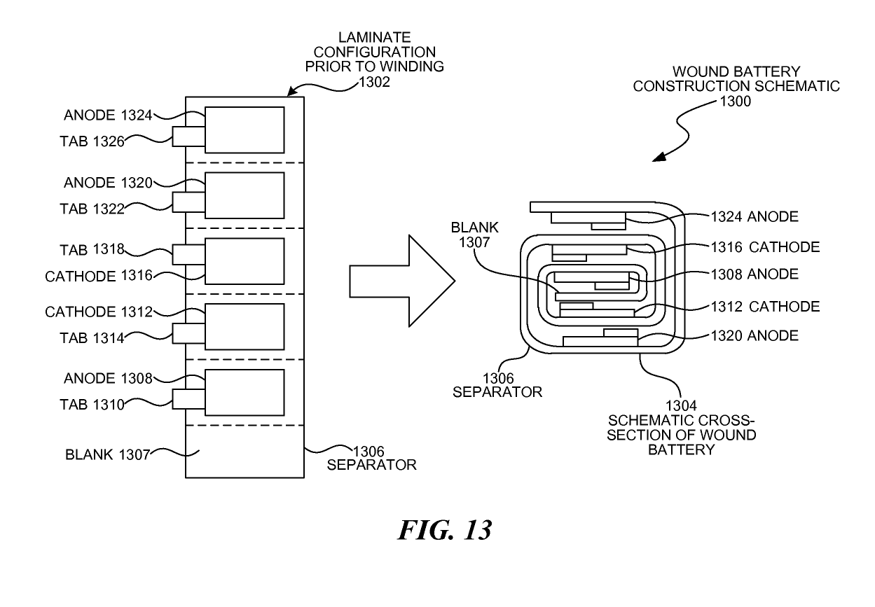

FIG. 13 is a schematic diagram of an embodiment 1300 showing a wound battery construction. Embodiment 1300 illustrates how a second of laminate containing battery components attached to battery separator may be wound into a flat battery.

Embodiment 1300 shows a laminate configuration 1302 prior to winding and a cross section of a wound battery 1304 after winding.

The laminate configuration 1302 contains a section of laminate that is ready for winding. The separator 1306 is shown with a blank area 1307 and several anodes and cathodes attached to the separator. The various anodes and cathodes may be positioned, along with various current collector tabs so that when the laminate 1302 is wound, the appropriate anodes and cathodes are placed next to each other and so that the respective tabs for the anodes and cathodes are properly positioned.

The separator 1306 is shown with anode 1308 and tab 1310, cathode 1312 and tab 1314, cathode 1316 and tab 1318, anode 1320 and tab 1322, and anode 1324 and tab 1326.

When wound up into the wound battery 1304, the blank 1307 separates anode 1308 and cathode 1312. The wound battery 1304 shows the anode 1324 at the top, then cathode 1316, anode 1308, cathode 1312, and anode 1320 at the bottom.

Embodiment 1300 is an example of one of many configurations that may have anodes, cathodes, and other battery components placed on a single laminate.

In one particular process, large sheets of separator may be manufactured with many electrode assemblies attached. The electrode assemblies may be placed onto a conveyor with or without a carrier sheet, and the coater may apply a solution from which a microporous separator may be formed.

Once the separator is formed and dried, the sheets may be placed on an alignment fixture and stacked several sheets high. In one embodiment, the sheets may have alternating anode and cathode electrode assemblies. After stacking several sheets, the separator layers may be heat sealed and cut, creating individual battery cells.

Another potential benefit may be achieved in applying these concepts to the production of wound cells. In this case, there is opportunity to significantly reduce assembly time and cost for individual cells by eliminating handling electrodes and separators separately. Unlike current manufacturing procedures where it can be difficult to maintain separator/electrode and anode/cathode alignment, the electrode assemblies may be positioned prior to creating the separator layer. The positioning may be such that the electrodes may be properly positioned when a subassembly may be wound. Such a subassembly may have several anodes and cathodes bonded to a single separator layer, and the subassembly may be wound around one of the electrodes to create a wound battery cell.

Many of the embodiments use a high-volume film coating machine to cast a separator layer onto other battery components. Battery components may include anodes, cathodes, metal current collector foils, packaging films or other materials. The term “electrodes” may be used to describe battery components used with the separator material, but the same concepts may be applied to other battery components as well.

In many embodiments, the electrodes may be discrete pieces of battery components that are pre-cut to a desired size and shape. In some embodiments, the electrodes may be manufactured in a continuous roll and cut to shape in a manufacturing process, such as by die cutting.

The casting process may use a substrate, such as a sacrificial film that may be used to carry the battery components through a casting machine. In some embodiments, battery components may be placed directly on a conveyor for casting without the use of a casting substrate. In many embodiments, the casting substrate may be removed prior to assembling electrode subassemblies into a battery cell.

The casting process may cast the separator layer onto an electrode in wet form, as a separator solvent/polymer slurry that may or may not contain a non-woven web or other reinforcing materials, creating adhesion to the surface of the electrode. The adhesion may be sufficient so that the electrodes may adhere to the separator layer during subsequent processing steps. In some cases, the adhesion may not be very strong. Subsequent processing steps may include delamination (peeling away of a plastic or foil casting substrate on which the materials are deposited), or movement of a delaminated sheet containing one or more separator/electrode constructions to a separate location for stacking, folding, cutting, edge sealing, thermal lamination, packaging or some other processing step.

The electrodes may be produced in a number of different configurations. In some embodiments, the electrodes may be double-sided electrodes, having a metal foil current collector, on both sides of which are active anode or cathode material. Such an embodiment may be useful for producing multilayer cell stacks of larger capacity in subsequent assembly steps. When such an electrode may be covered with a separator layer through a casting process, it may then be stacked with similar electrode assemblies of opposite polarity to construct a battery cell of whatever capacity is desired. For example, a double-sided cathode assembly may be stacked onto a double-sided anode assembly to form a single electrochemical couple. Another anode assembly may be stacked onto the cathode assembly to form a second couple. One may add a second cathode assembly, then a third anode assembly, and so on until a battery cell assembly of the desired capacity is formed.

In many embodiments, the separator layer may contain a reinforcing web. The reinforcing web may be a woven or non-woven web. The casting process may consist of first saturating the web with a separator solvent/polymer solution that will form a porous separator film upon gelation and drying. The saturated web may then be laid onto the electrode or other components while still wet. For many of the concepts discussed here, similar results may be achieved by casting an appropriate separator solvent/polymer solution (or modified variant thereof) directly onto the electrode.

In some embodiments, layers of separator may extend beyond the edges of the active material on some or all of the electrodes by at least several millimeters to prevent potential shorting between electrodes in the completed cell assembly.

In some embodiments, the surface area of cathodes may be slightly less than that of adjacent anodes for optimal electrochemical performance of the completed cell.

In some embodiments, an uncoated bare metal portion of a current collector on each electrode may extend beyond the separator layers in the final cell assembly to facilitate the intra-cell connection of all electrodes of like polarity, as well as connection to external circuits.

In some embodiments, continuous strips of electrode material may be used as input to the coating process, rather than pre-cut pieces. In such an embodiment, continuously coated electrode/separator sheets may be cut to size in a subsequent processing step. In such an embodiment, such a process may result in at least one edge of the cut electrode assembly that may not have a separator layer extending beyond the edge of the electrode's active material. Several potential means of addressing this issue are discussed below.

Some embodiments may have equipment to feed pre-cut electrodes onto the supporting substrate prior to coating. Such equipment may allow separator to overhang on all edges of the electrode pieces. While this may increase complexity of the up-front production equipment configuration, it can significantly decrease the complexity of the equipment required to process the separator/electrode sheets into complete cell assemblies.

In some embodiments, some portion of a current collector (the “tab”) may be exposed outside of the separator so that the current collectors may be attached to a battery pole. In one such embodiment, the casting process may be arranged so that the tab is not coated with separator material during the casting process. One such mechanism may be to arrange the tab to be outside the casting region. Another such mechanism may be to selectively cast separator material in a manner that avoids placing separator material on top of the tab area. One such mechanism may be to use a screen or programmable openings in a casting apparatus.

In some embodiments where separator material may be cast on a tab region, a mechanism may be made for removing the separator coating from the tabs following the coating process. One mechanism may be a solvent dip that may dissolve away separator from the tab.

Single Cell Manufacturing Scenario:

In a single-cell production, continuous electrodes may be fed into coater.

Prepare rolls of anode and cathode with one long edge trimmed so that both the current collector foil and the active material terminate at the trimmed edge. Uncoated current collector foil should extend beyond active material on the other long edge.

Orient one or two continuous strips of anode on a casting substrate with a space in between them and current collector foil edges placed so as to extend beyond the separator layer after coating. It may be necessary to tack the anode strips to the supporting substrate to maintain proper placement while coating, though the separator coating, once applied, may secure the strip in place without any additional support.

Orient one or two continuous strips of cathode on a supporting film substrate in like manner.

Apply a full-width coating of separator to the electrode strips so that all active material is coated but current collectors extend beyond one or both edges of the separator after coating.

After coating, delaminate the supporting substrate from the electrode/separator assemblies, leaving the electrode strip(s) secured to the separator film. This may be done as part of the following step, or the entire roll of material may be delaminated in batch mode prior to the following step.

Prepare single electrode/separator assemblies by unwinding, delaminating (if necessary), and cutting a desired length of material, then cutting separator between electrodes so as to leave separator overhanging the active material on two edges of each electrode.

Form a cell stack assembly by placing the single electrode/separator assemblies in an alignment fixture and stacking them to the desired height, alternating anode/cathode/anode/cathode, etc., with current collectors of opposite polarities oriented 180 degrees away from each other.

Alternatively, feed one elongated single anode/separator assembly and one elongated single cathode/separator assembly together into a cell winder and wind up to create a cylindrical cell without alignment issues associated with loose separators.

Interleaf separator tapes (or add additional separator sheets) between anode & cathode layers at all cut edges.

Heat seal separators around edge of each cell flat stack assembly to hold them together for further processing.

Flat stacked cell, pre-cut electrodes fed into coater.

Pre-cut electrodes to size for the completed cell stack, cathode slightly smaller than the anode. Current collector tabs may be notched for maximum production efficiency (more cells can be produced in a single stacking process with notched current collectors).

All electrodes in a given coating run are either anodes or cathodes. Using a precision placement mechanism, place the pre-cut electrodes on the supporting substrate at regular intervals as the supporting substrate is fed into the coater, with the current collector tabs placed so as to extend beyond the separator layer after coating. As an alternative, the pre-cut electrodes may be precisely located and tacked onto the substrate in advance, using a small amount of adhesive that is compatible with the electrochemistry of the cell.

Coat pre-cut anodes with continuous full-width separator layer so that all active material is coated but current collectors extend beyond one or both edges of the separator after coating.

Coat pre-cut cathodes with continuous full-width separator layer in a similar manner, with the same alignment as anodes.

After coating, delaminate the supporting substrate from the rest of the assembly, leaving the electrodes secured to the full-width separator film. This may be done as part of the following step, or the entire roll of material may be delaminated in batch mode prior to the following step.

Create a cut sheet by unwinding, delaminating (if necessary), and cutting a length of full-width material containing one or more electrodes. Place the cut sheet in an alignment fixture.

Repeat this process with a second cut sheet strip containing electrodes of the opposite polarity. Place the second cut sheet on top of the previous sheet in an alignment fixture.

Continue this process with cut sheets stacked anode/cathode/anode/cathode, etc. until cell stack assemblies with the desire electrochemical capacity are achieved.

Cut and heat seal separators to form individual cell stacks from the full-width sheet

Flat-Wound Cell, Pre-Cut Electrodes Fed Into Coater.

Pre-cut electrodes to the size required for the completed cell stack, cathode slightly smaller than the anode. Current collector tabs may be notched.

Using a precision placement mechanism, place the pre-cut electrodes on the supporting substrate, alternating anodes and cathodes, using variable spacing as the supporting substrate is fed into the coater. Current collector tabs must be placed so as to extend beyond the separator layer after coating. Electrode spacing must be such that when wound in a subsequent step the various electrode layers will align properly and all adjacent electrodes will be separated by a separator layer. Two alternating anode/cathode streams may be processed simultaneously, one at either edge of the single separator layer and each with current collectors oriented outward. As an alternative, the pre-cut electrodes may be precisely located and tacked onto the substrate in advance, using a small amount of adhesive that is compatible with the electrochemistry of the cell.

Coat pre-cut electrodes with continuous full-width separator layer so that all active material is coated but current collectors extend beyond one or both edges of the separator after coating.

After coating, delaminate the supporting substrate from the full-width strip, leaving the electrodes secured to the separator film. This may be done as part of the following step, or the entire roll of material may be delaminated in batch mode prior to the following step.

Unwind, delaminate (if necessary) and feed the material into a cell winder with a flat mandrel until the desired number of winds is achieved. Cut the tail of the material and remove the wound assembly from the mandrel. If two cells have been wound simultaneously, the separator between them is cut to form two complete wound cell stack assemblies.

Double-Coated Anodes, Uncoated Cathodes, Continuous Electrode Strips Fed Into Coater

Prepare rolls of anode with one edge trimmed so that no current collector foil extends beyond active material. Uncoated current collector foil should extend beyond active material on other edge.

Pre-cut cathodes to the size required for the completed cell stack and slightly smaller than the anode.

Prepare a roll of separator coated on a supporting film substrate. This will be used in place of the plain supporting film substrate used in other processes described here.

Orient one or two continuous strips of anode on the separator-coated supporting film substrate with a space in between them and current collector foil edges placed so as to extend beyond the separator layer after coating. As an alternative embodiment, the bottom layer of separator may be coated onto the supporting film substrate during the same run and on the same coating machine that is applying the second top layer of separator, rather than preparing the bottom layer in advance. In this case, it is possible that the anode strips may be placed on the underlying separator layer while it is still slightly wet, which may offer some degree of adhesion between the two layers.

Apply a full-width top coating of separator to the anode strips so that all active material is coated but current collectors extend beyond one or both edges of the separator after coating.

After top coating, delaminate the supporting substrate from the separator/anode/separator assemblies, leaving the anode strip(s) secured between the separator films. This may be done as part of the following step, or the entire roll of material may be delaminated in batch mode prior to the following step.

Prepare single separator/anode/separator assemblies by unwinding, delaminating (if necessary), and cutting a desired length of material, then cutting separator between electrodes so as to leave separator overhanging the active material on two edges of each electrode.

Form a cell stack assembly by first placing a single separator/anode/separator assembly in an alignment fixture. Next place a precut cathode on top of the first assembly, centering it so that its edges are sufficiently distant from the two cut edges of the separator/anode/separator assembly. Continue stacking to the desired height, alternating anode/cathode/anode/cathode, etc. Current collectors may either be notched or collectors of opposite polarities are oriented 180o away from each other.

Alternatively, feed one elongated single anode/separator assembly and one elongated single cathode/separator assembly together into a cell winder and wind up to create a cylindrical cell without alignment issues associated with loose separators.

Additional separator tapes or separator sheets need not be interleafed between anode & cathode layers at cut edges since separator extends beyond all cathode cut edges in the double-coated anode design. Separator does not overhand cut edges of anode, but anode cut edges are not located adjacent to any cathode.

Heat seal separators around edge of each cell flat stack assembly to hold them together for further processing.

Other Production Variations

There are many similar alternatives based on the basic stacking/winding processes described above. For example, wound cells may be produced with current collectors at the electrode ends, rather than along the long edges as described previously. This would require either pre-cutting electrodes prepared with bare current collector at the ends, or cutting a continuous electrode roll to length and cleaning the electrode ends to expose the current collector.

Also, anodes and cathodes may be placed side-by-side on the preformed separator, a flexible cell packaging material or another form of casting substrate before coating, and various folding techniques may be used after coating to produce folded cell assemblies, which may or may not be combined with various stacking techniques to create larger assemblies. Such folds may occur in the machine or transverse direction of the web, or a combination of both.

The separator layer(s) may also be applied in a discontinuous manner so that it selectively covers the cut electrodes with the desired amount of overhang. This may be done with spray coating devices, computer controlled ink jet style applicators or other automated applicators, or with a mechanism to cut and place pre-saturated pieces of nonwoven web.

Laminated cell packaging foils may be used as the initial coating substrate on which to build the cell stack assemblies in cases where pre-cut electrodes are fed into the coater. In this case, any overhanging separator layers that would impede the final sealing of the packaging materials must be removed prior to final sealing. Using laminated cell packaging foils as the coating substrate may be particularly useful in simple folded designs, where a precut anode and cathode placed on the packaging foil may be overlaid by a single separator layer. Final assembly in this case would entail folding the assembly down the middle to create a simple cell with a single anode and cathode. The folded edge would not require sealing and would eliminate the need to remove the excess separator laid down on the substrate between the electrodes that would otherwise interfere with proper package sealing along that edge.

The above folding technique would result in a cell with a double separator layer. In many applications this could be an advantage by reducing the likelihood of through-holes in the separator. A doubled separator could similarly be an advantage in many of the winding and stacking processes described here.

Any of the proposed processes may potentially be made more efficient by using one or more surface treatments, such as solvent pretreatments or corona discharges, to either the separator or the electrodes, or both, to enhance the bonding between the layers. These treatments could be performed either in-line as one step of the coating process, or during a previous batch process.

Thermal bonding (via applied heat and pressure, sonic or microwave bonding, or some other technique) may be used to advantage in many of the processes contemplated here. Such thermal techniques could be used to apply pre-cast separator to adjacent materials instead of casting a separator in place and using solvent casting as the primary adhesive mechanism, or it could be used to create an adhesion between any of the unsecured layers created by dry lay-down or stacking as described here. Further, various chemical or hot-melt adhesives may be used (with or without externally applied heat) to bond any of the layers described here.

Finally, a significant improvement in production efficiency would likely be attained if electrode active material were coated and calendared on the same coating machine during the same run in which separator materials are coated. This potential long-term objective would require significant study and evaluation but remains a very interesting concept.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
preparing a plurality of battery components;
placing at least some of said plurality of battery components such that each of said battery components are not in contact with another battery component;
attaching said plurality of battery components to a continuous separator membrane;
cutting said continuous separator membrane into laminate subassemblies; and
forming a battery from said laminate subassemblies.

2. The method of claim 1, said attaching comprising forming said continuous separator membrane on top of said plurality of battery components.

3. The method of claim 2, said forming comprising casting.

4. The method of claim 3, said casting comprising:
forming a solution comprising a dissolved polymer in a first liquid and a second liquid;
removing at least a portion of said first liquid such that said polymer begins gelation;
after said gelation has begun, removing said second liquid.

5. The method of claim 4, said battery components being placed on a conveyor.

6. The method of claim 4, said battery components being placed on a carrier film.

7. The method of claim 4, said battery components being placed on a second continuous separator membrane.

8. The method of claim 1, said attaching comprising applying heat to said continuous separator membrane.

9. The method of claim 1, said attaching comprising a solvent to said continuous separator membrane.

10. The method of claim 1, said battery components being precut to size prior to said attaching.

11. The method of claim 1, said continuous separator membrane having a reinforcing web.

12. The method of claim 1, said forming comprising heat bonding a first laminate subassembly to a second laminate subassembly by fusing separators attached to said laminate subassemblies.

13. The method of claim 1, said laminate subassemblies comprising a portion of separator membrane extending past a portion of said battery component.

14. The method of claim 1, said battery being formed by stacking a plurality of said laminate subassemblies.

15. The method of claim 1, said battery being formed by winding at least one of said laminate subassemblies.

16. The method of claim 1, said battery components comprising at least one of a group composed of:
an anode;
a cathode;
a packaging film; and
a conductive foil.

17. A method comprising:
preparing a plurality of battery components;
forming a solution comprising a dissolved polymer in a first liquid and a second liquid;
bringing at least one of said plurality of battery components in contact with said solution;
while said at least one of said plurality of battery components is in contact with said solution, removing at least a portion of said first liquid such that said polymer begins gelation and after said gelation has begun, removing said second liquid to form a separator membrane on said battery component.

18. The method of claim 17, said method further comprising:
cutting said continuous separator membrane into laminate subassemblies; and
forming a battery from said laminate subassemblies.

19. The method of claim 18, said method further comprising:
heat sealing at least two of said laminate subassemblies by heat sealing said separator membranes.

20. The method of claim 19, said method further comprising:
forming said battery by stacking said laminate subassemblies.
